(19) United States
(12) Patent Application Publication
(10) Pub. No.: US 2026/0226275 A1
(43) Pub. Date: Aug. 6, 2026

(54) SYSTEM FOR FORMING ASPHALT PELLETS

(71) Applicant: CERTAINTEED LLC, Malvern, PA (US)

(72) Inventors: William R. BAILEY, Tumwater, WA (US); William P. Dempsey, Issaquah, WA (US)

(21) Appl. No.: 19/531,975

(22) Filed: Feb. 6, 2026

Related U.S. Application Data
(60) Provisional application No. 63/754,901, filed on Feb. 6, 2025.

(51) Int. Cl. C08L 95/00; C08J 3/12

(52) U.S. Cl. CPC C08L 95/00; C08J 3/128; C08J 2395/00; C08J 2491/00; C08L 2555/22; C08L 2555/50; C08L 2555/64

(57) ABSTRACT

According to one aspect, a system for the production of asphalt pellets includes a shaping device and an encapsulation drum. As compared to other coating and pelletization methods and systems, the present system is more energy efficient and produces a more uniform product. The produced pellets may comprise:
1) wherein average estimated thickness of the shells is no greater than 1 mm and no more than 1% of the core surface area is exposed;
2) a circularity of at least 0.01;
3) an inverse aspect ratio of at least 0.01;
4) or a solidity of at least 0.01.

### CROSS-REFERENCE TO RELATED APPLICATION(S)

This application claims priority under 35 U.S.C. § 119 (e) to U.S. Provisional Patent Application No. 63/754,901, entitled “IMPROVED SYSTEM FOR FORMING ASPHALT PELLETS,” filed Feb. 6, 2025, by William R. BAILEY et al., which is assigned to the current assignee hereof and is incorporated herein by reference in its entirety.

### FIELD OF THE DISCLOSURE

The present disclosure is directed to systems for the production of asphalt pellets for use in hot mix asphalt production.

### SUMMARY

According to one aspect, a system for the production of asphalt pellets includes a shaping device and an encapsulation drum. As compared to other coating and pelletization methods and systems, the present system is more energy efficient and produces a more uniform product. The produced pellets may comprise:
1) wherein average estimated thickness of the shells is no greater than 1 mm and no more than 1% of the core surface area is exposed;
2) a circularity of at least 0.01;
3) an inverse aspect ratio of at least 0.01;
4) or a solidity of at least 0.01.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a pellet according to an embodiment.

FIG. 2 includes a flowchart of an exemplary system for forming asphalt pellets according to an embodiment.

FIG. 3 includes an illustration of an encapsulation drum.

### DETAILED DESCRIPTION

The following is directed to asphalt pellets for pavement compositions including shells that contain calcined gypsum, providing for improved durability and storage.

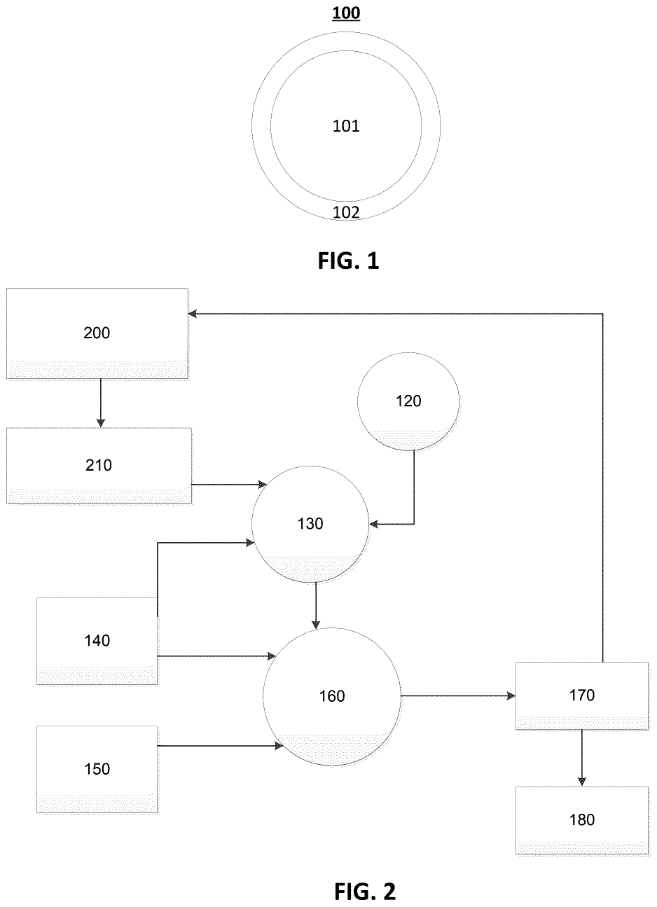

FIG. 1 includes an illustration of a pellet 100 according to an embodiment. The pellet 100 can have a core 101 and a shell 102. The pellets are suitable for various storage and transportation conditions.

FIG. 2 includes an illustration of an exemplary system for forming pellets according to an embodiment. The system can begin with a recycled asphalt material processor 200, a recycled asphalt material hopper 210, softening agent dispenser 220, shaping device 230, an encapsulation drum 260, and/or finishing screen 270. Optionally, the recycled asphalt material processor and recycled asphalt material hopper may be one device.

According to one embodiment, recycled asphalt material processor 200 receives the recycled asphalt material as it enters into the process. If the recycled asphalt material is pre-ground to a predetermined size, this step can be skipped. If the recycled asphalt material has not been ground, it is comminuted to a predetermined particle size and transferred into the recycled asphalt material hopper 210.

According to an embodiment, the comminuted recycled asphalt material can then be transferred into a shaping device 230, such as a pelletizer, pelleting disc, briquette press, extruder or similar device. The shaping device 230 can further include a material inlet for receiving the comminuted recycled asphalt material particles, a sizing disk or press for forming recycled asphalt material cores of a predetermined size, a material outlet for transferring the cores from the shaping device, a first inlet for receiving a softening agent from a softening agent dispenser 220, and, optionally, a second inlet for receiving shell material from a shell material dispenser 240. As comminuted recycled asphalt material particles enter the shaping device 130 from the recycled asphalt material hopper 210, they are combined with a softening agent from a dispenser 220 and, optionally, shell material, such as hydrated lime or recycled gypsum supplied by a shell material dispenser 240 to form an agglomeration. The agglomeration is then sized to form cores. The cores are then transferred to the encapsulation drum 260 through a material inlet.

In an embodiment, the core may include a particular asphalt binder that may provide for improved performance and or manufacturing of the pellets. The asphalt binder may also provide for reduced environmental impact. In an embodiment, the core can include recycled asphalt material. In an embodiment, the recycled asphalt material can include recycled asphalt shingles, recycled asphalt pavement, or a combination thereof. The recycled asphalt shingles can include post industrial waste, post-consumer waste, or a combination thereof. The asphalt shingle waste can be in a size from about 20-40 mesh to about 0.25 inches.

In an embodiment, the cores 101 may include a particular amount of recycled asphalt material that may facilitate improved performance and/or manufacturing of the asphalt pellets. The recycled asphalt material content may also provide for reduced environmental impact. In an embodiment, the core can include at least 5 wt % recycled asphalt material or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % recycled asphalt material. In another embodiment, the core can include no greater than 99 wt % recycled asphalt material or no greater than 98 wt % or no greater than 97 wt % or no greater than 96 wt % or no greater than 95 wt % recycled asphalt material. It will be appreciated that the core can include a range of recycled asphalt material between any of the minimum and maximum values noted above, including for example, at least 10 w % and not greater than 99 wt % or at least 90 wt % and not greater than 96 wt %.

In an embodiment, the core can comprise a softening agent. The softening agent can have a particular composition that may facilitate improved performance and/or manufacturing of the asphalt pellets. The softening agent composition may also provide for reduced environmental impact. In an embodiment, the softening agent can comprise a petroleum distillate, performance grade asphalt, bio-oil, a vegetable oil, biofuel, a biodiesel, a biodiesel residue oil, Tall-oil, heavy vacuum gas oil (HVGO), fatty acid methyl esters (FAME), reclaimed motor oil, reclaimed cutting oil, pine tar or a combination thereof. In a particular embodiment, the softening agent can include biodiesel residue oil.

In an embodiment, the cores 101 may include a particular amount of softening agent that may facilitate improved performance and/or manufacturing of the asphalt pellets. The softening agent content may also provide for reduced environmental impact. In an embodiment, the core can include at least 1 wt % softening agent or at least 2 wt % or at least 3 wt % or at least 4 wt % or at least 5 wt % or at least 6 wt % or at least 7 wt % or at least 8 wt % softening agent. In another embodiment, the core can include no greater than 30 wt % softening agent or no greater than 25 wt % or no greater than 20 wt % or no greater than 15 wt % or no greater than 10 wt %. It will be appreciated that the core can include a range of softening agent between any of the minimum and maximum values noted above, including for example, at least 1 wt % and not greater than 10 wt % or at least 5 wt % and not greater than 10 wt %.

In an embodiment, the core can comprise an additive. The additive can have a particular composition that may facilitate improved performance and/or manufacturing of the asphalt pellets. The additive composition may also provide for reduced environmental impact. In an embodiment, the additive can comprise tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polycyclic aromatic hydrocarbons (PAHs), sodium polyacrylate polymers, styrene butadiene styrene rubbers (SBS), styrene butadiene rubbers (SBR), paper, comprises carbon black, a colorant, cellulose, or a combination thereof.

After the cores 101 are formed, the cores can be transferred to an encapsulation drum 260 through a material inlet. The encapsulation drum 260 includes an internal tumbling and coating system. As the cores tumble through the encapsulation drum 260, shell material may be dispensed into the encapsulation drum 260 through shell material dispenser 240 and other components of the encapsulation coating may be dispensed onto the core from a coating dispenser 250. The encapsulation drum 160 may further include drying system.

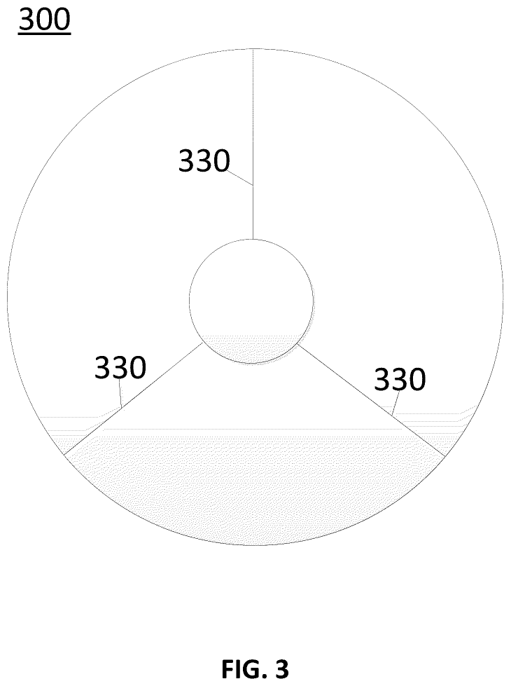

FIG. 3 provides an internal view of the encapsulation drum 300. More specifically, as the cores are tumbled through the encapsulation drum 300, an encapsulation coating including a liquid blend of binding/waterproofing agent and shell material enters the rotating encapsulation drum 300 through a fixed encapsulation coating dispenser inlet and a fixed shell material dispenser inlet.

As the cores are tumbled against lifting bars 330 and the interior surface of the encapsulation drum 300, they are continuously coated and re-coated with the encapsulation coating. The finished encapsulated pellets are then dried with heat from the dryer, or alternatively, at ambient temperature as they exit the encapsulation drum 300 through a material outlet. The encapsulation drum improves the process by reducing energy consumption as compared to known pelletization and coating systems. The simultaneous tumbling and coating of the cores within the encapsulation drum 300 results in less clumping of the cores and provides more control, accuracy and proper material ratios of the coating components as the cores are coated as they proceed through the encapsulation drum 300. The encapsulated pellets formed with the encapsulation drum have a more consistent shape and shell size as compared to capsules formed with separate pelletization and coating processes.

In an embodiment, the shell material of the encapsulation coating may have a particular composition that may facilitate improved performance and/or manufacturing of the asphalt pellets. The shell material composition may also provide for reduced environmental impact. In an embodiment, the shell material composition can include calcined gypsum, sometimes colloquially referred to as stucco. The calcined gypsum can include calcium sulfate hemihydrate. The calcined gypsum can further include other additives. In an embodiment, the calcined gypsum can be recycled gypsum, such as gypsum from recycled plasterboards. The calcined gypsum can include a particular sulfur content and/or calcium content. In an embodiment, the shell composition can include recycled polyethylene, a water-resistant polymer, a wax, mineral fines, or ground plastic fines, or a combination thereof. In another embodiment, the shell composition can include mineral fines. In an even more particular embodiment, the shell composition can include lime fines. In an even more particular composition, the shell can include hydrated lime. In an embodiment, the shell material can include any combination of the materials in this paragraph.

In an embodiment, the encapsulation may include a particular content of shell material that may facilitate improved performance and/or manufacturing of the asphalt pellets. The shell material content may also provide for reduced environmental impact. In an embodiment the encapsulation coating can include at least 5 wt % shell material or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % shell material. In an embodiment, the encapsulation coating can include no greater than 99 wt % calcined gypsum or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % shell material. It will be appreciated that the shell material content can be between any of the minimum and maximum values noted above, including for example, but not limited to, at least 80 wt % and not greater than 99 wt % or at least 95 wt % and no greater than 99 wt %.

In an embodiment, the shell encapsulation coating can further include a water-resistant agent or an adhesive. The water-resistant agent or adhesive can be lignin. The adhesive and water-resistant agent can be fed from coating dispenser 250 into encapsulation drum 260 to be agglomerated as part of the shell composition. In an alternative embodiment, the shell can include a hydrophobic polymer, a hydrophilic polymer, a hydrophobic cellulose, a polyvinyl alcohol, molasses or molasses derivatives, latex, polysaccharides, or latex.

In an embodiment, the shell composition can further include an additive that may facilitate improved performance and/or manufacturing of the asphalt pellet. The additive may also provide for reduced environmental impact. In an embodiment, the additive can be tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polycyclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

In an embodiment, the pellet shells may have a particular average estimated thickness that may facilitate improved performance and/or manufacturing of the of the pellets. In an embodiment, the average estimated thickness of the shells can be no greater than wherein the average estimated thickness of the shells is no greater than 1 mm or no greater than 950 μm or no greater than 900 μm or no greater than 850 μm or no greater than 800 μm or no greater than 750 μm or no greater than 700 μm or no greater than 650 μm or no greater than 600 μm or no greater than 550 μm or no greater than 500 μm or no greater than 450 μm or no greater than 400 μm or no greater than 350 μm or no greater than 300 μm or no greater than 250 μm or no greater than 200 μm or no greater than 150 μm or no greater than 100 μm or no greater than 95 μm or no greater than 90 μm or no greater than 85 μm or no greater than 80 μm or no greater than 75 μm or no greater than 70 μm or no greater than 65 μm or no greater than 60 μm or no greater than 55 μm or no greater than 50 μm or no greater than 45 μm or no greater than 40 μm or no greater than 35 μm or no greater than 30 μm or no greater than 25 μm or no greater than 20 μm or no greater than 15 μm or no greater than 10 μm or no greater than 5 μm. This estimated shell thickness can still be achieved while leaving no greater than 1% of the core exposed, or no greater than 0.1% or none of the core exposed. The estimated pellet shell thickness may be estimated according to the methods specified in the examples.

In an embodiment, the pellets may have a particular circularity that may facilitate improved performance and/or manufacturing of the pellets. In an embodiment, the pellets may have a circularity of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99. In another embodiment, the pellets may have a circularity of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05. It will be appreciated that the circularity of the pellets may be between any of the minimum and maximum values noted above, including for example, but not limited to, at least 0.01 and not greater than 1 or at least 0.50 and not greater than 1.

In an embodiment, the pellets may have a particular inverse aspect ratio that may facilitate improved performance and/or manufacturing of the of the pellets. In an embodiment, the pellets may have an inverse aspect ratio of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99. In another embodiment, the pellets may have a inverse aspect ratio of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05. It will be appreciated that the inverse aspect ratio of the pellets may be between any of the minimum and maximum values noted above, including for example, but not limited to, at least 0.01 and not greater than 1 or at least 0.50 and not greater than 1.

In an embodiment, the pellets may have a particular solidity that may facilitate improved performance and/or manufacturing of the pellets. In an embodiment, the pellets may have a solidity of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99. In another embodiment, the pellets may have a solidity of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05. It will be appreciated that the solidity of the pellets may be between any of the minimum and maximum values noted above, including for example, but not limited to, at least 0.01 and not greater than 1 or at least 0.50 and not greater than 1.

Referring again to FIG. 2, after the encapsulated pellets exit the encapsulation drum 260, they pass through a finish screen 270 that separates any oversized capsules from the finished capsules. If oversized capsules are present, they can be transferred back into the recycled asphalt material processor 200 for reprocessing. This allows the system to convert 100% of the recycled asphalt material feedstock into new products with zero waste allowing for carbon capture and perpetual recycling of the carbon containing materials that are currently disposed of in landfills. Alternatively, if the predetermined size will not result in oversized product, the finished encapsulated pellets are transferred directly into storage 280.

After the finished encapsulated pellets are placed in storage 280 and cured for 12 hours, and preferably for 48 hours before use. The finished encapsulated pellets have a shelf life of at least one year. This process rejuvenates recycled asphalt material to usable, in-spec HMA paving grade asphalt, thereby allowing it to be used within hot mix asphalt production without the need for the pre-blending of additives prior to the HMA manufacturing process.

In an embodiment, the pellets can have a particular average crush strength, which may facilitate improved performance and/or manufacturing of the pellets. The crush strength may also provide for reduced environmental impact. In an embodiment, the pellets can have a crush strength of at least 20 N or at least 25 N or at least 30 N or at least 35 N or at least 40 N or at least 45 N or at least 50 N. In an embodiment, the batch can have a crush strength of no greater than 100 N. It will be appreciated that crush strength may be within a range having any of the minimum and maximum values noted above.

In an embodiment, the asphalt content in the pellets have a particularly low temperature performance grade that may facilitate improved performance and/or manufacturing of the asphalt pellets. The low temperature performance grade may also provide for reduced environmental impact. In an embodiment, the asphalt can have a low temperature performance grade of no greater than 0° C. or no greater than −2° C. or no greater than −4° C. or no greater than −6° C. or no greater than −8° C. or no greater than −10° C. or no greater than −12° C. or no greater than −14° C. or no greater than −16° C. or no greater than −18° C. or no greater than −20° C. or no greater than −22° C. or no greater than −24° C. or no greater than −26° C. In another embodiment the asphalt can have a low temperature performance grade of at least −50° C. or at least −48° C. or at least −46° C. or at least −44° C. or at least −42° C. or at least −40° C. It will be appreciated that the low temperature performance grade may be between any of the minimum and maximum values noted above.

In an embodiment, the asphalt content in the pellets may have a particular high temperature performance grade that may facilitate improved performance and/or manufacturing of the asphalt pellets. The high temperature performance grade may also provide for reduced environmental impact. In an embodiment, the asphalt can have a high temperature performance grade of at least 50° C. or at least 52° C. or at least 54° C. or at least 56° C. or at least 58° C. or at least 60° C. or at least 62° C. or at least 64° C. or at least 66° C. or at least 68° C. or at least 70° C. or at least 72° C. or at least 74° C. or at least 76° C. or at least 78° C. or at least 80° C. In another embodiment the asphalt can have a high temperature performance grade of less than 100° C. or less than 98° C. or less than 96° C. or less than 94° C. or less than 92° C. or less than 90° C. It will be appreciated that the high temperature performance grade may be between any of the minimum and maximum values noted above.

Pavement grading is conducted in accordance with AASHTO R29 and AASHTO M320. The pavement grade is a characteristic of the asphalt within the pellets. The low temperature and high temperature performance grades are indicative of the lowest and highest temperatures at which the asphalt compositions can perform as pavement in low traffic conditions without failure.

### Embodiments

Embodiment 1. A batch of asphalt pellets, each asphalt pellet comprising:
a core comprising an asphalt binder,
a encapsulation coating comprising a shell material,
wherein the batch of pellets comprise at least one of the following:
   1) wherein average estimated thickness of the shells is no greater than 1 mm and no more than 1% of the core surface area is exposed;
   2) a circularity of at least 0.01;
   3) an inverse aspect ratio of at least 0.01;
   4) or a solidity of at least 0.01.

Embodiment 2. The batch of embodiment 1, wherein the average estimated thickness of the shells is no greater than 1 mm or no greater than 950 μm or no greater than 900 μm or no greater than 850 μm or no greater than 800 μm or no greater than 750 μm or no greater than 700 μm or no greater than 650 μm or no greater than 600 μm or no greater than 550 μm or no greater than 500 μm or no greater than 450 μm or no greater than 400 μm or no greater than 350 μm or no greater than 300 μm or no greater than 250 μm or no greater than 200 μm or no greater than 150 μm or no greater than 100 μm or no greater than 95 μm or no greater than 90 μm or no greater than 85 μm or no greater than 80 μm or no greater than 75 μm or no greater than 70 μm or no greater than 65 μm or no greater than 60 μm or no greater than 55 μm or no greater than 50 μm or no greater than 45 μm or no greater than 40 μm or no greater than 35 μm or no greater than 30 μm or no greater than 25 μm or no greater than 20 μm or no greater than 15 μm or no greater than 10 μm or no greater than 5 μm.

Embodiment 3. The batch of embodiment 1 or embodiment 2, wherein the pellets exhibit an average circularity of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99.

Embodiment 4. The batch of any one of embodiments 1 to embodiment 3, wherein the pellets exhibit an average circularity of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05.

Embodiment 5. The batch of any one of embodiments 1 to embodiment 4, wherein the pellets exhibit an average inverse aspect ratio of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99.

Embodiment 6. The batch of any one of embodiments 1 to embodiment 5, wherein the pellets exhibit an average inverse aspect ratio of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05.

Embodiment 7. The batch of any one of embodiments 1 to embodiment 6, wherein the pellets exhibit an average solidity of at least 0.01 or at least 0.05 or at least 0.10 or at least 0.15 or at least 0.20 or at least 0.25 or at least 0.30 or at least 0.35 or at least 0.40 or at least 0.45 or at least 0.50 or at least 0.55 or at least 0.60 or at least 0.65 or at least 0.70 or at least 0.75 or at least 0.80 or at least 0.85 or at least 0.90 or at least 0.95 or at least 0.99.

Embodiment 8. The batch of any one of embodiments 1 to embodiment 7, wherein the pellets exhibit an average solidity of no greater than 1.00 or no greater than 0.95 or no greater than 0.90 or no greater than 0.85 or no greater than 0.80 or no greater than 0.75 or no greater than 0.0 or no greater than 0.65 or no greater than 0.60 or no greater than 0.55 or no greater than 0.50 or no greater than 0.45 or no greater than 0.40 or no greater than 0.35 or no greater than 0.30 or no greater than 0.25 or no greater than 0.20 or no greater than 0.15 or no greater than 0.10 or no greater than 0.05.

Embodiment 9. The batch of any one of embodiments 1 to embodiment 8, wherein the batch comprises an average crush strength of at least 20 N or at least 25 N or at least 30 N or at least 35 N or at least 40 N or at least 45 N or at least 50 N.

Embodiment 10. The batch of any one of embodiments 1 to embodiment 9, wherein the batch comprises an average crush strength of not greater than 100 N.

Embodiment 11. The batch of any one of embodiments 1 to embodiment 10, wherein the batch comprises a low temperature performance grade of no greater than 0° C. or no greater than −2° C. or no greater than −4° C. or no greater than −6° C. or no greater than −8° C. or no greater than −10° C. or no greater than −12° C. or no greater than −14° C. or no greater than −16° C. or no greater than −18° C. or no greater than −20° C. or no greater than −22° C. or no greater than −24° C. or no greater than −26° C.

Embodiment 12. The batch of any one of embodiments 1 to embodiment 11, wherein the batch comprises a low temperature performance grade of at least −50° C. or at least −48° C. or at least −46° C. or at least −44° C. or at least −42° C. or at least −40° C.

Embodiment 13. The batch of any one of embodiments 1 to embodiment 12, wherein the batch comprises a high temperature performance grade of at least 50° C. or at least 52° C. or at least 54° C. or at least 56° C. or at least 58° C. or at least 60° C. or at least 62° C. or at least 64° C. or at least 66° C. or at least 68° C. or at least 70° C. or at least 72° C. or at least 74° C. or at least 76° C. or at least 78° C. or at least 80° C.

Embodiment 14. The batch of any one of embodiments 1 to embodiment 13, wherein the batch comprises a high temperature performance grade of less than 100° C. or less than 98° C. or less than 96° C. or less than 94° C. or less than 92° C. or less than 90° C.

Embodiment 15. The batch of any one of embodiments 1 to embodiment 14, wherein the core further comprises recycled asphalt material.

Embodiment 16. The batch of embodiment 15, wherein the recycled asphalt material comprises recycled asphalt shingles, recycled asphalt pavement, or a combination thereof.

Embodiment 17. The batch of embodiment 15 or embodiment 16, wherein the recycled asphalt shingles comprises post-consumer waste, postindustrial waste, or a combination thereof.

Embodiment 18. The batch of any one of embodiments 15 to 17, wherein the core comprises at least 5 wt % recycled asphalt material or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % recycled asphalt material.

Embodiment 19. The batch of any one of embodiments 15 to 18, wherein the core comprises no greater than 99 wt % recycled asphalt material or no greater than 98 wt % or no greater than 97 wt % or no greater than 96 wt % or no greater 95 wt % or no greater than 94 wt % or no greater than 93 wt % or no greater than 92 wt % recycled asphalt material.

Embodiment 20. The batch of any one of embodiments 1 to 19, wherein the core further comprises a softening agent.

Embodiment 21. The batch of embodiment 20, wherein the core comprises at least 1 wt % softening agent or at least 2 wt % or at least 3 wt % or at least 4 wt % or at least 5 wt % or at least 6 wt % or at least 7 wt % or at least 8 wt % softening agent.

Embodiment 22. The batch of embodiment 20 or embodiment 21, wherein the core comprises no greater than no greater than 30 wt % softening agent or no greater than 25 wt % or no greater than 20 wt % or no greater than 15 wt % or no greater than 10 wt % softening agent.

Embodiment 23. The batch of any one of embodiments 20 to 22, wherein the softening agent comprises a petroleum distillate, performance grade asphalt, bio-oil, a vegetable oil, biofuel, a biodiesel, a biodiesel residue oil, Tall-oil, HVGO, FAME, reembodimented motor oil, reembodimented cutting oil, pine tar or a combination thereof.

Embodiment 24. The batch of any one of embodiments 20 to 23, wherein the softening agent comprises a biodiesel residue oil.

Embodiment 25. The batch of any one of embodiments 1 to 24, wherein the core further comprises an additive.

Embodiment 26. The batch of embodiment 25, wherein the additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polycyclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 27. The batch of any one of embodiments 1 to 26, wherein the core comprises a diameter of at least 0.01 in and no greater than 0.5 in.

Embodiment 28. The batch of any one of embodiments 1 to 27, wherein the batch comprises an average diameter of at least 0.01 in and no greater than 2 in.

Embodiment 29. The batch of any one of embodiments 1 to 28, wherein the shell material comprises recycled polyethylene, a water-resistant polymer, a wax, mineral fines, or ground plastic fines, or a combination thereof.

Embodiment 30. The batch of any one of embodiments 1 to 29, wherein the shell material comprises mineral fines.

Embodiment 31. The batch of any one of embodiments 1 to 30, wherein the shell material comprises lime fines.

Embodiment 32. The batch of any one of embodiments 1 to 31, wherein the shell material comprises hydrated lime.

Embodiment 33. The batch of any one of embodiments 1 to 32, wherein the shell material comprises gypsum.

Embodiment 34. The batch of embodiment 33, wherein the gypsum comprises calcined gypsum or recycled gypsum.

Embodiment 35. The batch of any one of embodiments 1 to 34, wherein the shell comprises at least 5 wt % shell material or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % shell material.

Embodiment 36. The batch of any one of embodiments 1 to 35, wherein the encapsulation coating comprises no greater than 99 wt % shell material or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % shell material.

Embodiment 37. The batch of any one of embodiments 1 to 36, wherein the encapsulation coating further comprises a water-resistant agent.

Embodiment 38. The batch of any one of embodiments 1 to 37, wherein the encapsulation coating further comprises an adhesive.

Embodiment 39. The batch of any one of embodiments 1 to 38, wherein the encapsulation coating further comprises lignin.

Embodiment 40. The batch of any one of embodiments 1 to 39, wherein the encapsulation coating further comprises a hydrophobic polymer, a hydrophilic polymer, a hydrophobic cellulose, a polyvinyl alcohol, molasses or molasses derivatives, latex, polysaccharides, or latex, or any combination thereof.

Embodiment 41. The batch of any one of embodiments 1 to 40, wherein the encapsulation coating further comprises a shell additive.

Embodiment 42. The batch of embodiment 41, wherein the encapsulation coating additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polycyclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 43. The batch of any one of embodiments 1 to 42, wherein the encapsulation coating comprises 10-20 wt % of each pellet.

Embodiment 44. The batch of any one of embodiments 1 to 43, wherein the core comprises 80-90 wt % of each pellet.

Embodiment 45. A method of preparing a batch of asphalt pellets comprising:
agglomerating asphalt with a shaping device to form asphalt pellet cores;
tumbling the asphalt pellet cores with an encapsulation coating in an encapsulation drum to form asphalt pellets.

Embodiment 46. The method of embodiment 45, wherein the shaping device comprises a pelleted disc.

Embodiment 47. The method of embodiment 45 or embodiment 46, further comprising drying the coated pellets.

Embodiment 48. The method of any one of embodiments 45 to 47, further comprising drying the coated pellets at a temperature of 120-160° F.

Embodiment 49. The method of any one of embodiments 45 to 48, further comprising drying the coated pellets in the encapsulation drum.

Embodiment 50. The method of any one of embodiments 45 to 49, wherein the method does not include drying the pellets.

Embodiment 51. The method of any one of embodiments 45 to 50, wherein the batch of pellets comprise or consist of the batch of any one of embodiments 1 to 44.

Embodiment 52. A system for the production of asphalt pellets comprising:
a shaping device comprising a shaping device outlet and an encapsulation drum comprising an interior rotating drum a first encapsulation drum inlet;
wherein the shaping device outlet feeds into the first encapsulation drum inlet.

Embodiment 53. The system of embodiment 52, wherein the shaping device further comprises a first shaping device inlet.

Embodiment 54. The system of embodiment 53, wherein the first shaping device inlet is configured to receive processed recycled asphalt material.

Embodiment 55. The system of any one of embodiments 52 to 55, wherein the shaping device further comprises a second shaping device inlet.

Embodiment 56. The system of embodiment 55, wherein the second shaping device inlet is configured to receive softening agent.

Embodiment 57. The system of embodiment 55 or embodiment 56, further comprising a softening agent dispenser configured to dispense softening agent to the second shaping device inlet.

Embodiment 58. The system of any one of embodiments 52 to 57, wherein the shaping device further comprises a third shaping device inlet.

Embodiment 59. The system of embodiment 58, wherein the third shaping device inlet is configured to receive shell material.

Embodiment 60. The system of embodiment 58 or embodiment 59, comprising a softening agent dispenser configured to dispense shell material to the third shaping device inlet.

Embodiment 61. The system of any one of embodiments 52 to 60, wherein the shaping device is configured to shape recycled asphalt material and optionally a softening agent and/or shell material into asphalt pellet cores.

Embodiment 62. The system of embodiment 52 to 61, further comprising a recycled asphalt material processor and a recycled asphalt material hopper.

Embodiment 63. The system of embodiment 62, wherein the recycled asphalt material processor and the recycled asphalt material hopper are a single device.

Embodiment 64. The system of embodiment 62 or embodiment 63, wherein the recycled asphalt material hopper comprises a hopper outlet configured to transfer processed recycled asphalt material to the first shaping device inlet.

Embodiment 65. The system of any one of embodiments 52 to 64, wherein the encapsulation drum inlet is configured to receive asphalt pellet cores from the shaping device.

Embodiment 66. The system of any one of embodiments 52 to 65, wherein the encapsulation drum further comprises a second encapsulation drum inlet.

Embodiment 67. The system of embodiment 66, wherein the second encapsulation drum inlet is configured to receive shell material.

Embodiment 68. The system of embodiment 66 or embodiment 67, comprising a shell material dispenser configured to dispense shell material to the second encapsulation drum inlet.

Embodiment 69. The system of any one of embodiments 52 to 68, wherein the encapsulation drum further comprises a third encapsulation drum inlet.

Embodiment 70. The system of embodiment 69, wherein the third encapsulation drum inlet is configured additional components of the encapsulation coating comprising lignin, water, a water-resistant binder, or a combination thereof.

Embodiment 71. The system of embodiment 69 or embodiment 70, comprising an encapsulation coating dispenser configured to dispense configured additional components of the encapsulation coating to the third encapsulation drum inlet.

Embodiment 72. The system of any one of embodiments 52 to 71, wherein the encapsulation drum further comprises an encapsulation drum outlet.

Embodiment 73. The system of any one of embodiments 52 to 72, wherein the system further comprises a finishing screen.

Embodiment 74. The system of any one of embodiments 52 to 73, wherein the encapsulation drum further comprises a dryer.

### Examples

### Example 1—Preparation of Pellets

Samples S1 and CS1 were prepared according to the following steps having the composition outline in Table 1.

TABLE 1

| | | |
|---|---|---|
| Sample | S1 | CS1 |

Core Composition

| | | |
|---|---|---|
| Recycled | 84-86 | 84-86 |
| Asphalt Shingle | wt % | wt % |
| (Post Industrial) | | |
| Softening Agent | 14-16 | 14-16 |
| | wt % | wt % |

Shell Composition

| | | |
|---|---|---|
| Gypsum | 100 wt % | 100 |
| | | wt % |

Pellet cores were prepared in a pelletizer disc having the composition detailed above in Table 1. The core materials were pelletized until the cores had a diameter of about 0.25-0.5 in.

The softening agent included Bio-Residue Oil from renewable energy group (REG). For sample CS1, the cores are transported to a second pelletizer disc where the encapsulation coating are applied until the shell covers at least 99% of the core. For sample S1, cores were transferred to an encapsulation drum where the encapsulation coating at least 99% of the core.

Analysis on the size and consistency of the pellet and shell shape and size is being conducted according to the following procedures:

### Example 2: Shape Analysis

Shells are sieve sorted according to size and then fed into a vibratory bowl feeder. The shells are fed in front of a camera and are provided with a backlight to eliminate shadows. Frames are collected and measurements on circularity, inverse aspect ratio and solidity are taken. Formulas for the shape measurements are provided below:

$$Circularity = \frac{4 π \times Area}{{Perimeter}^{2}} \times {( 1 - \frac{0.5}{\frac{Perimeter}{2 π} + 0.5} )}^{2}$$

$$Aspect Ratio Inverse = \frac{{Width}_{minor axis}}{{Length}_{major axis}}$$

$$Solidity = \frac{Pixel {Area}_{particle}}{Pixel {Area}_{convex hull}}$$

The width and length for the aspect ratio inverse can be measured on an ellipse drawn around the particle (See e.g. FIG. 4).

The convex hull used in the solidity measurement refers to the smallest convex polygon that can contain the image of the pellet (See e.g. FIG. 5).

### Example 3: Shell Size Analysis

Samples are weighed and then submerged in 50% aqua regia leaching solution for 3 hours. Samples were then removed from the solution and allowed to fully dry. The samples are weight again and the decrease in weight is attributed to the gypsum content.

The results of the acid leach test were used to estimate coating thickness based on the diameter and weight of the pellets, the shell coating density, and an assumption that the pellets are approximately spherical. The resulting coating thickness estimate may be referred to as an estimated shell thickness herein.

What is claimed is:

1. A batch of asphalt pellets, each asphalt pellet comprising:
a core comprising an asphalt binder,
a encapsulation coating comprising a shell material,
wherein the batch of pellets comprise at least one of the following:
1) wherein average estimated thickness of the shells is no greater than 1 mm and no more than 1% of the core surface area is exposed;
2) a circularity of at least 0.01;
3) an inverse aspect ratio of at least 0.01;
4) or a solidity of at least 0.01.

2. The batch of claim 1, wherein the average estimated thickness of the shells is no greater than 1 mm.

3. The batch of claim 1, wherein the pellets exhibit an average circularity of at least 0.01 and no greater than 1.00.

4. The batch of claim 1, wherein the pellets exhibit an average inverse aspect ratio of 0.01 and no greater than 1.00.

5. The batch of claim 1, wherein the pellets exhibit an average solidity of at least 0.01 and no greater than 1.00.

6. The batch of claim 1, wherein the batch comprises an average crush strength of at least 20 N.

7. The batch of claim 1, wherein the core further comprises recycled asphalt material.

8. The batch of claim 7, wherein the recycled asphalt material comprises recycled asphalt shingles, recycled asphalt pavement, or a combination thereof.

9. The batch of claim 7, wherein the recycled asphalt shingles comprises post consumer waste, post industrial waste, or a combination thereof.

10. The batch of claim 1, wherein the core further comprises a softening agent.

11. The batch of claim 10, wherein the softening agent comprises a petroleum distillate, performance grade asphalt, bio-oil, a vegetable oil, biofuel, a biodiesel, a biodiesel residue oil, Tall-oil, HVGO, FAME, reclaimed motor oil, reclaimed cutting oil, pine tar or a combination thereof.

12. The batch of claim 10, wherein the softening agent comprises a biodiesel residue oil.

13. A method of preparing a batch of asphalt pellets comprising:
agglomerating asphalt with a shaping device to form asphalt pellet cores;
tumbling the asphalt pellet cores with an encapsulation coating in an encapsulation drum to form asphalt pellets.

14. The method of claim 13, wherein the shaping device comprises a pelleter disc.

15. The method of claim 13, further comprising drying the coated pellets.

16. The method of claim 13, further comprising drying the coated pellets at a temperature of 120-160° F.

17. The method of claim 13, further comprising drying the coated pellets in the encapsulation drum.

18. The method of claim 13, wherein the method does not include drying the pellets.

19. The method of claim 13, wherein the batch of pellets comprises pellets comprising:
a core comprising an asphalt binder,
a encapsulation coating comprising a shell material,
wherein the batch of pellets comprise at least one of the following:
1) wherein average estimated thickness of the shells is no greater than 1 mm and no more than 1% of the core surface area is exposed;
2) a circularity of at least 0.01;
3) an inverse aspect ratio of at least 0.01;
4) or a solidity of at least 0.01.

20. A system for the production of asphalt pellets comprising:
a shaping device comprising a shaping device outlet
and an encapsulation drum comprising an interior rotating drum a first encapsulation drum inlet;
wherein the shaping device outlet feeds into the first encapsulation drum inlet.
